(19) United States
(12) Patent Application Publication
(10) Pub. No.: US 2012/0300594 A1
(43) Pub. Date: Nov. 29, 2012

(54) PRESSURE WAVE GENERATOR AND DEVICE INCLUDING THE SAME

(75) Inventors: Hiroshi OGURA, Kyoto (JP); Norio KIMURA, Kanagawa (JP)

(73) Assignee: Panasonic Corporation, Osaka (JP)

(21) Appl. No.: 13/570,992

(22) Filed: Aug. 9, 2012

Related U.S. Application Data
(63) Continuation of application No. PCT/JP2010/003717, filed on Jun. 3, 2010.

(30) Foreign Application Priority Data
Feb. 16, 2010 (JP) 2010-031251

(51) Int. Cl. H04R 19/00

(52) U.S. Cl. 367/181; 367/140; 367/188

(57) ABSTRACT

A pressure wave generator includes a silicon substrate, a hole formed in the silicon substrate, and a film covering the hole. The film includes a multilayer film of a heat generating member and a heat insulating layer.

### CROSS-REFERENCE TO RELATED APPLICATIONS

This is a continuation of PCT International Application PCT/JP2010/003717 filed on Jun. 3, 2010, which claims priority to Japanese Patent Application No. 2010-031251 filed on Feb. 16, 2010. The disclosures of these applications including the specifications, the drawings, and the claims are hereby incorporated by reference in their entirety.

### BACKGROUND

The present disclosure relates to devices which generate pressure waves by heating a gas, such as air, etc., irradiates an object with the pressure waves, and detects the pressure waves reflected from the object, and more particularly, to devices which transmit and receive ultrasonic waves (frequency: 20 kHz or more).

Most conventional ultrasonic wave generation devices employ mechanical vibration generated by the piezoelectric effect. However, in order to generate the piezoelectric effect, it is necessary to use a highly environmentally hazardous piezoelectric material, such as lead (Pb), etc. In view of environmental load, a technique of generating ultrasonic waves without need of lead (Pb) has been sought. A piezoelectric element for use in the ultrasonic wave generation device is typically formed into an element shape by sintering a piezoelectric material. However, such a forming technique is not compatible with semiconductor manufacturing processes, and it is disadvantageously difficult to produce a fine structure using this technique.

To address the problem, a thermally induced pressure wave generation device which generates pressure waves by heating a medium, such as air, etc., has been proposed (see, for example, Japanese Patent Publication No. 2002-186097 (hereinafter referred to as “PATENT DOCUMENT 1”), Japanese Patent No. 3705926 (hereinafter referred to as “PATENT DOCUMENT 2”), and Nature, Vol. 400 (26 Aug. 1999), pp 853-855, “Thermally induced ultrasonic emission from porous silicon” (hereinafter referred to as “NON-PATENT DOCUMENT 1”), etc.). For example, PATENT DOCUMENT 1 describes a loudspeaker which includes a heat insulating layer provided on a substrate and a heat generating electrode provided on the heat insulating layer. PATENT DOCUMENT 2 and NON-PATENT DOCUMENT 1 describe use of porous silicon as a material for a heat insulating layer. Japanese Patent No. 3845077, Japanese Patent No. 3865736, and Japanese Patent Publication No. 2008-161816 (hereinafter referred to as “PATENT DOCUMENTS 3-5,” respectively) describe a technique of improving the heat insulating capability of a heat insulating layer, a technique of reducing cracks occurring in a heat insulating layer or a heat generating electrode, etc.

### SUMMARY

However, the efficiency of heat generation by heat generating members has not been studied in the conventional art. In the conventional art, although the ultrasonic wave generation device has been described, a mechanism for receiving ultrasonic waves has not been described.

The present disclosure describes implementations of a technique of the efficiency of heat generation by a heat generating member in a pressure wave generator corresponding to an ultrasonic wave generator, etc., by using a semiconductor manufacturing technique. The present disclosure also describes implementations of a technique of reducing or preventing cracks from occurring in a heat generating member or a heat insulating layer in a pressure wave generator. The present disclosure also describes implementations of a single device which performs both transmission and reception of pressure waves, such as ultrasonic waves, etc.

Note that not all the objects listed above need to be accomplished by the present disclosure, and at least one of the objects may be accomplished.

The present inventor has created a novel or improved pressure wave generator and a device including the pressure wave generator, which will be briefly described hereinafter.

An example pressure wave generator of the present disclosure includes a silicon substrate, a hole formed in the silicon substrate, and a film covering the hole. The film includes a multilayer film of a heat generating member and a heat insulating layer.

The pressure wave generator of the present disclosure is of thermally induced type. Therefore, an environmentally hazardous material, such as Pb, etc., is not used, and therefore, the environmental load can be reduced. Moreover, if a pressure wave generating portion is formed of the film having a small mass which includes the heat generating member and the heat insulating layer, the heat capacity of the heat generating member can be advantageously reduced, and the efficiency of heat generation can be advantageously improved.

The heat generating member is preferably formed of polysilicon doped with boron or phosphorus.

A surface of the heat generating member opposite to a side on which the heat insulating layer is formed, and a side surface of the heat generating member, are preferably covered by a barrier layer including an insulating film.

The heat insulating layer is preferably a multilayer film of a silicon oxide film and a silicon nitride film.

The silicon oxide film is preferably covered by the silicon nitride film.

In the film, the heat generating member and the heat insulating layer are preferably successively stacked together from a side on which the hole is provided.

The heat generating member preferably generates pressure waves on a side opposite to a side on which the heat insulating layer is formed.

A pad is preferably formed on the heat generating member, and an alternating current is preferably applied via the pad to the heat generating member.

Another example device according to the present disclosure includes the aforementioned pressure wave generator and a pressure wave receiver. The pressure wave receiver includes a capacitor including a vibration film and a fixed film.

Both the pressure wave generator and the pressure wave receiver are provided in this single device of the present disclosure. Therefore, the size of the entire device can be advantageously reduced, and the pressure wave generator and the pressure wave receiver can be advantageously more easily controlled.

This device preferably further includes a cover covering the pressure wave generator and the pressure wave receiver. The pressure wave generator and the pressure wave receiver are preferably mounted on a printed circuit board.

The cover preferably includes an opening corresponding to each of the pressure wave generator and the pressure wave receiver.

The cover may include a first opening corresponding to the pressure wave generator and a second opening corresponding to the pressure wave receiver.

The printed circuit board may include a first opening corresponding to the pressure wave generator and a second opening corresponding to the pressure wave receiver.

A mesh is preferably formed at each of the first and second openings.

The pressure wave generator and the pressure wave receiver are preferably formed on the same silicon substrate.

The pressure wave receiver preferably further includes a silicon substrate having a hole, and the hole in the silicon substrate of the pressure wave receiver and the hole in the silicon substrate of the pressure wave generator preferably share a space.

There are preferably a plurality of the pressure wave receivers mounted on the printed circuit board and are preferably arranged in a line on the printed circuit board.

There may be a plurality of the pressure wave receivers mounted on the printed circuit board and may be arranged in a cross shape on the printed circuit board.

There may be a plurality of the pressure wave receivers mounted on the printed circuit board and may be arranged in an L-shape on the printed circuit board.

The device may be electrically connected to another electronic device at a surface of the printed circuit board and the cover perpendicular to a surface of the printed circuit board on which the pressure wave generator is mounted.

The device may be electrically connected to another electronic device at a surface of the printed circuit board opposite to a surface of the printed circuit board on which the pressure wave generator is mounted.

The another electronic device may include a controller which controls the pressure wave generator and the pressure wave receiver.

The device may be electrically connected to the another electronic device via a bump formed on the surface of the printed circuit board opposite to the surface of the printed circuit board on which the pressure wave generator is mounted.

The heat generating member and a vibration electrode included in the vibration film are preferably formed of the same material, and the heat insulating layer and parts other than the vibration electrode of the vibration film are preferably formed of the same material.

According to the present disclosure, a pressure wave generator which does not contain lead (Pb), which is hazardous to the human body, and a device including the pressure wave generator, can be provided.

### BRIEF DESCRIPTION OF THE DRAWINGS

FIG. 1A is a plan view showing a structure of a pressure wave generator according to a first embodiment of the present disclosure.

FIG. 1B is a cross-sectional view taken along line Ib-Ib of FIG. 1A.

FIG. 2A is a diagram schematically showing how the pressure wave generator of the first embodiment of the present disclosure generates pressure waves.

FIG. 2B is a diagram showing continuous pressure waves which can be generated by the pressure wave generator of the first embodiment of the present disclosure.

FIG. 2C is a diagram showing a single pulse pressure wave which can be generated by the pressure wave generator of the first embodiment of the present disclosure.

FIG. 3A is a plan view showing a pressure wave generator according to a first variation of the first embodiment of the present disclosure.

FIG. 3B is a plan view showing a pressure wave generator according to a second variation of the first embodiment of the present disclosure.

FIG. 4 is a plan view showing a pressure wave generator according to a third variation of the first embodiment of the present disclosure.

FIG. 5 is a plan view showing a pressure wave generator according to a fourth variation of the first embodiment of the present disclosure.

FIG. 6 is a perspective view showing a device according to a second embodiment of the present disclosure.

FIG. 7 is a diagram for describing the mechanism of detection of a detection target by the device of the second embodiment of the present disclosure.

FIGS. 8A and 8B are perspective views showing example arrangements of pressure wave receivers.

FIG. 9A is a plan view showing a structure of the pressure wave receiver.

FIG. 9B is a cross-sectional view taken along line IXb-IXb of FIG. 9A.

FIG. 10A is a cross-sectional view showing a device according to a first variation of the second embodiment of the present disclosure.

FIG. 10B is a cross-sectional view showing a device according to a second variation of the second embodiment of the present disclosure.

FIG. 11A is a perspective view showing a device according to a third variation of the second embodiment of the present disclosure.

FIG. 11B is a cross-sectional view showing the device of the third variation of the second embodiment of the present disclosure.

FIG. 12A is a cross-sectional view showing a device according to a fourth variation of the second embodiment of the present disclosure, taken along line XIIa-XIIa of FIG. 12B.

FIG. 12B is a bottom view showing the device of the fourth variation of the second embodiment of the present disclosure.

FIG. 13A is a diagram showing a device according to a fifth variation of the second embodiment of the present disclosure, taken along line XIIIa-XIIIa of FIG. 13B.

FIG. 13B is a bottom view showing the device of the fifth variation of the second embodiment of the present disclosure.

### DETAILED DESCRIPTION

Materials and values described herein are for illustrative purposes only. The present disclosure is not limited to embodiments described herein. Various changes and modifications can be made without departing the spirit and scope of the present disclosure. The embodiments described herein may be combined with other embodiments unless clearly contradictory.

### First Embodiment

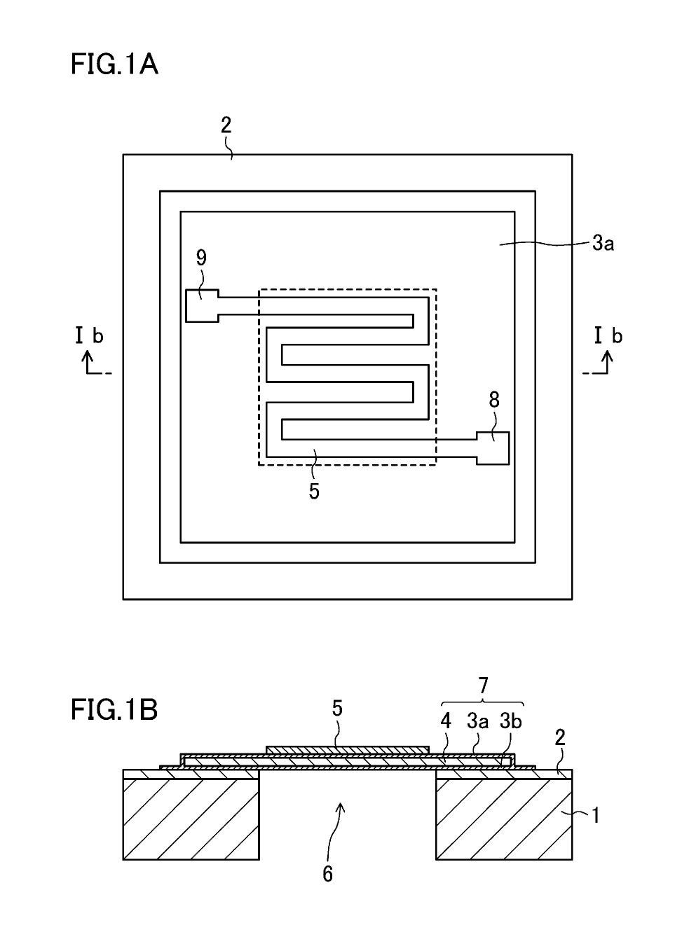

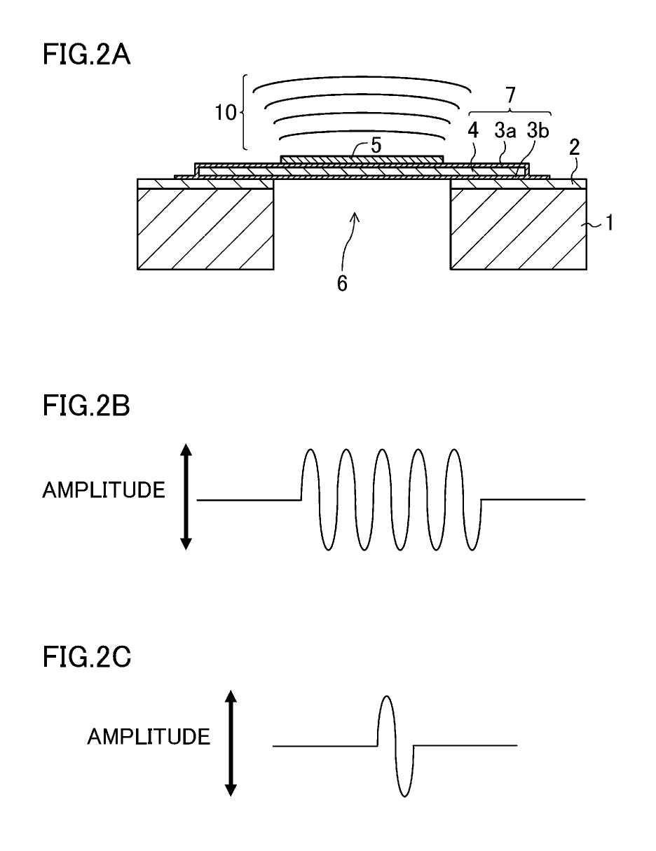

A first embodiment of the present disclosure will be described with reference to FIGS. 1A and 1B and 2A-2C.

As shown in FIGS. 1A and 1B, a pressure wave generator according to the present disclosure includes a silicon substrate 1 having a hole 6, a silicon oxide film 2 formed on the silicon substrate 1, and a heat generating member 5 and a heat insulating layer 7 covering the hole 6. The heat insulating layer 7 is a multilayer film of a first insulating film 4 and second insulating films 3a and 3b. Here, the hole 6 is formed by etching the silicon substrate 1 using a semiconductor manufacturing process. Note that, as shown in FIG. 1B, the hole 6 preferably penetrates through the silicon substrate 1. The heat generating member 5 is preferably formed of a polysilicon film doped with boron or phosphorus. This is because such a heat generating member can be formed by a semiconductor process, such as low pressure-chemical vapor deposition (LP-CVD), etc. The resistance value of the heat generating member is adjusted by changing the dose of boron or phosphorus. The heat generating member may be formed of a high-resistance metal (e.g., nickel chromium (NiCr), tantalum (Ta), etc.), a nitride (e.g., tantalum nitride (TaN), etc.), or a cermet material (e.g., Ta-silicon oxide (SiO₂), etc.). In particular, because the cermet material has a high resistivity, the heat generating member formed of the cermet material can have a high resolution and a high resistance. Examples of the cermet material used in the thin film resistance member include Cr—SiO₂, niobium (Nb)—SiO₂, etc., in addition to Ta—SiO₂. These are typically formed by RF sputtering using, as a target, a sintered material of a metal and SiO₂. The first insulating film 4 is preferably formed of a silicon oxide film, and the second insulating films 3a and 3b are preferably formed of a silicon nitride film. The second insulating films 3a and 3b preferably completely cover the first insulating film 4.

Here, an alternating current flows through the heat generating member 5 via pads 8 and 9. When an alternating current is applied to the heat generating member 5, the heat generating member 5 is heated, whereby gas, such as air, etc., above the heat generating member 5 is heated. Here, the first insulating film 4 and the second insulating films 3a and 3b have a lower thermal conductivity than that of the heat generating member 5, and therefore, function as a heat insulating layer which does not conduct heat generated by the heat generating member 5 to other parts. By providing the heat insulating layer 7, heat energy generated by the heat generating member 5 can be highly efficiently conducted to ambient gas located on a side opposite to a surface on which the heat insulating layer 7 is formed, whereby pressure waves are generated by rarefaction and compression of the gas.

Note that the silicon oxide film has a thermal conductivity of 1.3 W/m·K, and silicon and polysilicon have a thermal conductivity of 168 W/m·K. Thus, the thermal conductivity of the silicon oxide film is 1/100 or less of that of silicon and polysilicon. Note that the silicon nitride film has a thermal conductivity similar to that of the silicon oxide film. Although the thermal conductivity of the heat generating member 5 is preferably 100 times or more as high as that of the heat insulating layer 7, the present disclosure is not limited to this example.

Next, the principle of generation of pressure waves by the pressure wave generator will be briefly described with reference to FIGS. 2A-2C. As shown in FIG. 2A, by applying an alternating current to the pads 8 and 9 formed on the heat generating member 5, the heat generating member 5 is heated, and in turn, a medium, such as air, etc., above the heat generating member is heated, whereby pressure waves 10 can be generated. The pressure wave generator of the present disclosure can generate pressure waves, for example, with the following patterns: continuous waves (FIG. 2B); and a single pulse wave (FIG. 2C). A desired pressure wave can be generated by changing the type of the input alternating current.

The pressure wave generator of the first embodiment of the present disclosure has a hollow structure in which the multilayer film of the heat generating member 5, the first insulating film 4, and the second insulating films 3a and 3b is supported by a portion around the hole 6 of the silicon substrate 1. Therefore, the mass of the entire generator can be reduced, resulting in a structure having a smaller heat capacity. This is because the mass of the diaphragm-like multilayer film can be reduced by employing the hollow structure, and the heat capacity is determined by the product of the specific heat and mass of the parts. By thus reducing the heat capacity of the pressure wave generator, the time required to increase the temperature of the heat generating member can be reduced, whereby the energy efficiency can be increased, and therefore, the efficiency of heat generation can be improved.

Although the heat insulating layer may be formed of a single insulating film, the heat insulating layer is preferably formed of a multilayer film including insulating films. More specifically, the heat insulating layer is more preferably formed of a multilayer film further including an insulating film having high tensile stress (e.g., a silicon nitride film, etc.) than of a single insulating film having high compressive stress (e.g., a silicon oxide film, etc.). When a silicon oxide film is formed, for example, by LP-CVD, the silicon oxide film has a compressive stress of about −120 N/m². On the other hand, when a silicon nitride film is formed by LP-CVD, the silicon nitride film has a tensile stress of about 1400 N/m². Therefore, for example, if the heat insulating layer having a thickness of as much as about 1 μm is formed of a single silicon nitride film, the heat insulating layer is broken by its own film stress. This is because the tension of the film generated at an end portion of the film is determined by the product of the stress and thickness of the film. Therefore, if the heat insulating layer 7 is formed of a multilayer film, then when the first insulating film 4 is an insulating film having high compressive stress, the second insulating films 3a and 3b are preferably insulating films having high tensile stress. Note that when, in the multilayer film, the silicon nitride film, the silicon oxide film, and the silicon nitride film are stacked in the stated order, it is preferable that the silicon oxide film be thicker than the silicon nitride in terms of the relationship in the magnitude of film tension. In addition, by adjusting the thicknesses of the first insulating film 4 and the second insulating films 3a and 3b, the resonant frequency can be controlled.

If the first insulating film 4 is a silicon oxide film, it is preferable that the first insulating film 4 be completely covered by the second insulating films 3a and 3b which are silicon nitride films, etc., which have low hygroscopicity. This is because the silicon oxide film has an action of significantly adsorbing moisture in the atmosphere, and the silicon nitride film protects the silicon oxide film from moisture in the atmosphere.

The heat generating member 5, and the multilayer film of the first insulating film 4 and the second insulating films 3a and 3b which functions as the heat insulating layer 7, may not be directly formed on the silicon substrate 1, and may be preferably supported by the portion around the hole 6 of the silicon substrate 1 with the silicon oxide film 2 being interposed between the heat insulating layer 7 and the silicon substrate 1.

(Variations of First Embodiment)

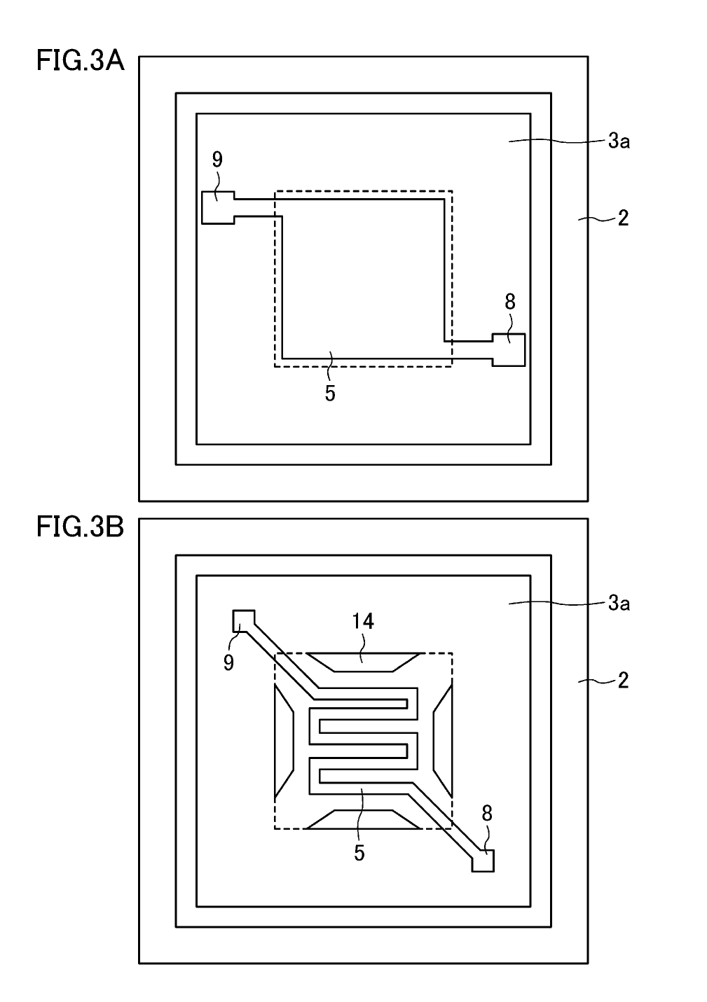

Pressure wave generators according to variations of the first embodiment of the present disclosure will be described with reference to FIGS. 3A-5.

In FIG. 1A, the heat generating member 5 has a meandering shape (rectangular shape). Alternatively, in a first variation of the first embodiment, as shown in FIG. 3A, the heat generating member 5 may have a flat-plate shape. In the case of the flat-plate shape, gas, such as air, etc., above the heat generating member can be heated in a two-dimensional manner, advantageously resulting in a continuous temperature distribution.

In FIGS. 1A and 1B, the first insulating film 4 and the second insulating films 3a and 3b corresponding to the heat insulating layer 7 are supported by the silicon substrate 1 along the entire perimeter thereof. Alternatively, in a second variation of the first embodiment, as shown in FIG. 3B, the first insulating film 4 and the second insulating films 3a and 3b corresponding to the heat insulating layer 7 may be partially supported by the silicon substrate 1. Specifically, a void 14 in which the silicon substrate 1 does not make contact with the diaphragm portion of the heat insulating layer 7 may be formed. In such an embodiment, the mass of the film including the heat generating member 5 and the heat insulating layer 7 can be further reduced, resulting in still higher energy efficiency. Also, the escape of heat to the silicon substrate 1 can be further reduced, resulting in still higher energy efficiency.

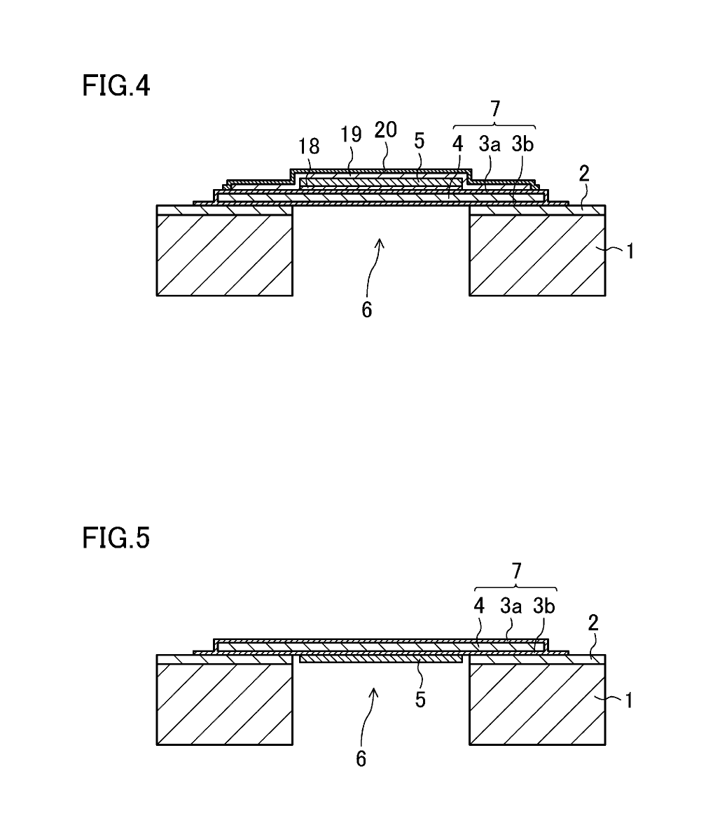

In FIG. 1B, the upper surface (opposite to the heat insulating layer 7) of the heat generating member 5 is exposed. Alternatively, in a third variation of the first embodiment, as shown in FIG. 4, the upper surface of the heat generating member 5 may be covered by a barrier film 19 and a barrier film 20 formed of an insulating film. When the heat generating member 5 generates heat, the temperature of the heat generating member 5 increases to 400° C. or more. If the temperature of the heat generating member 5 becomes high in the atmosphere, the heat generating member 5 may react with oxygen in the atmosphere, so that the resistance value may be changed from the initial state. In order to reduce or prevent such a phenomenon, the upper portion of the heat generating member 5 is preferably covered by a barrier film. Moreover, a side surface of the heat generating member 5 is preferably covered. In this case, the change in the resistance value of the heat generating member 5 can be reduced or prevented for a long term. Note that when the pressure wave generator of FIG. 4 is manufactured, then if the pressure wave generator is annealed in nitrogen atmosphere of 700-1100° C., the pressure wave generator can have heat resistance to 700° C. or more. Note that the lower surface of the heat generating member 5 may be covered by a barrier film 18 formed of an insulating film. Here, for example, the barrier films 18 and 20 are silicon nitride films, and the barrier film 19 is a silicon oxide film. The barrier film provided on the upper surface of the heat generating member 5 may be a single layer.

In FIG. 1B, the heat generating member 5 is formed on the upper side of the heat insulating layer 7. Alternatively, in a fourth variation of the first embodiment, as shown in FIG. 5, the heat generating member 5 may be formed on the lower side of the heat insulating layer 7 (a side on which the hole 6 is provided). In this case, pressure waves can be generated on the side on which the hole 6 is provided in the silicon substrate 1. Moreover, the direction in which the pressure waves travel can be limited to the shape of the hole 6, whereby the directivity of the pressure waves can be advantageously increased.

(Description of Manufacturing Method)

An example method for manufacturing the pressure wave generator of the first embodiment of the present disclosure will be briefly described hereinafter. Initially, the heat insulating layer 7 of an insulating film which is a single or multilayer film is deposited on the upper surface of the silicon substrate 1. Next, the heat generating member 5, for example, of a polysilicon film doped with boron or phosphorus is formed on the heat insulating layer 7. Next, the hole 6 is formed from the lower surface of the silicon substrate 1 by etching. In this case, it is preferable that the hole 6 penetrate to the upper surface of the silicon substrate 1 so that the film including the heat insulating layer 7 and the heat generating member 5 is exposed. Note that, here, as shown in FIGS. 1A and 1B, the heat insulating layer 7 and the heat generating member 5 are formed in the stated order. Alternatively, as shown in FIG. 5, the heat generating member 5 and the heat insulating layer 7 may be formed in the stated order.

### Second Embodiment

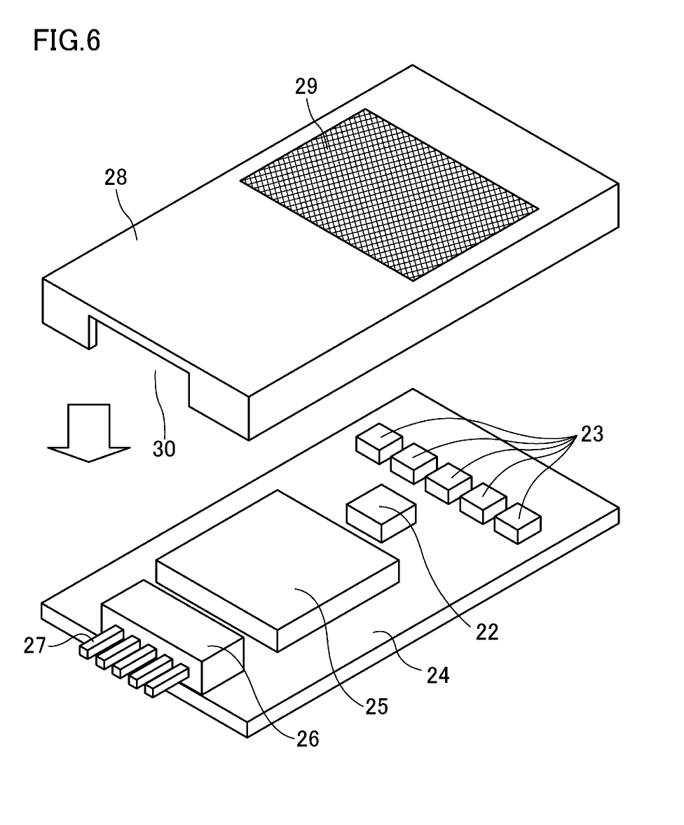

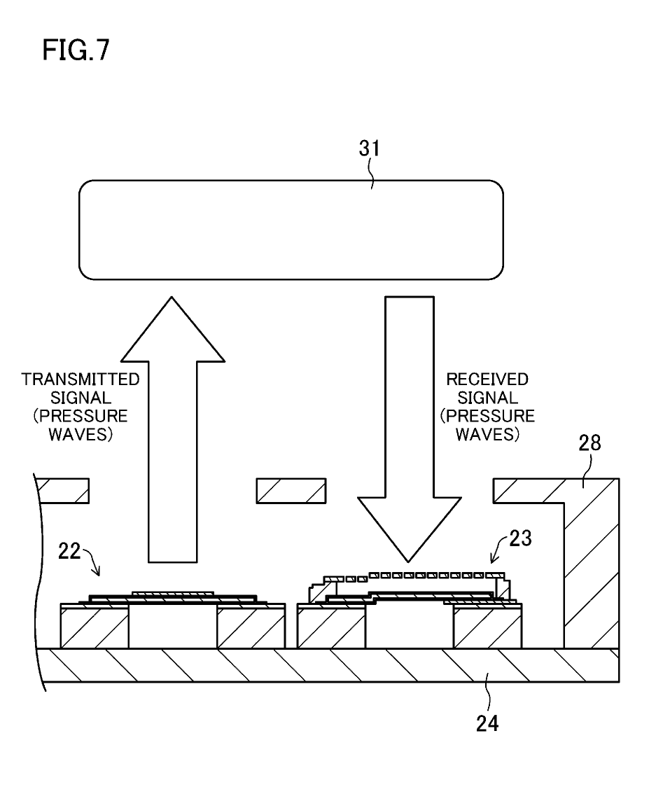

A second embodiment of the present disclosure will be described hereinafter with reference to FIGS. 6 and 7.

In this embodiment, a device including the pressure wave generator of the first embodiment of the present disclosure will be described.

As shown in FIG. 6, the pressure wave generator 22, pressure wave receivers 23, a controller 25 which controls generation and reception of pressure waves (e.g., the controller includes an LSI circuit), and a connector 26 including pins 27 which are used to connect electrical signals to an external electronic device, are mounted on a printed circuit board 24. A cover 28 is joined to the printed circuit board 24 to cover the pressure wave generator 22, the pressure wave receiver 23, the controller 25, and the connector 26. Note that the number of pressure wave receivers 23 mounted on the printed circuit board 24 is at least one. Note that, in order to accurately obtain two- or three-dimensional information of a detection target, a plurality of pressure wave receivers 23 may be arranged in at least one line.

Here, the cover 28 may be a metal cap formed of a metal, or may have a multilayer structure of a metal layer and an insulating layer in order to reduce or prevent external electrical noise. Note that, in this case, it is preferable that the metal layer cover all parts mounted on the printed circuit board 24, in terms of noise reduction or prevention.

An opening is formed in a surface of the cover 28 which faces the pressure wave generator 22 and the pressure wave receiver 23. A metal mesh 29 is preferably provided at the opening. This is because it is necessary to reduce or prevent dust from entering the inside of the cover, although pressure waves are transmitted and received through the opening. Note that separate openings may be provided, i.e., a first opening corresponding to the pressure wave generator 22 and a second opening corresponding to the pressure wave receiver 23. In this case, a mesh is preferably formed at each opening.

An opening 30 is preferably formed in a side wall portion of the cover 28. This is because the connector 26 including the pins 27 is prevented from making contact with the cover 28. The connector 26 allows the device of this embodiment to be electrically connected to another electronic device at a plane perpendicular to the surface of the printed circuit board 24 on which the pressure wave generator 22 is mounted.

Next, the mechanism of detection of a detection target by a device including the pressure wave generator of the present disclosure will be briefly described with reference to FIG. 7. In FIG. 7, the device is partially shown, i.e., a portion of the pressure wave generator 22, the pressure wave receiver 23, the opening, the cover 28, and the printed circuit board 24 is shown, and a portion of other parts, such as the connector 26, etc., is not shown.

As shown in FIG. 7, initially, the pressure wave generator 22 generates pressure waves (transmitted signal), and irradiates a detection target 31 with the pressure waves. Next, the pressure wave receiver 23 receives the pressure waves (received signal) reflected from the detection target 31. In this case, in order to reduce or prevent the transmitted signal from directly reaching the pressure wave receiver 23, a separation wall which separates the pressure wave generator 22 from the pressure wave receiver 23 may be formed.

(Arrangement of Pressure Wave Receivers)

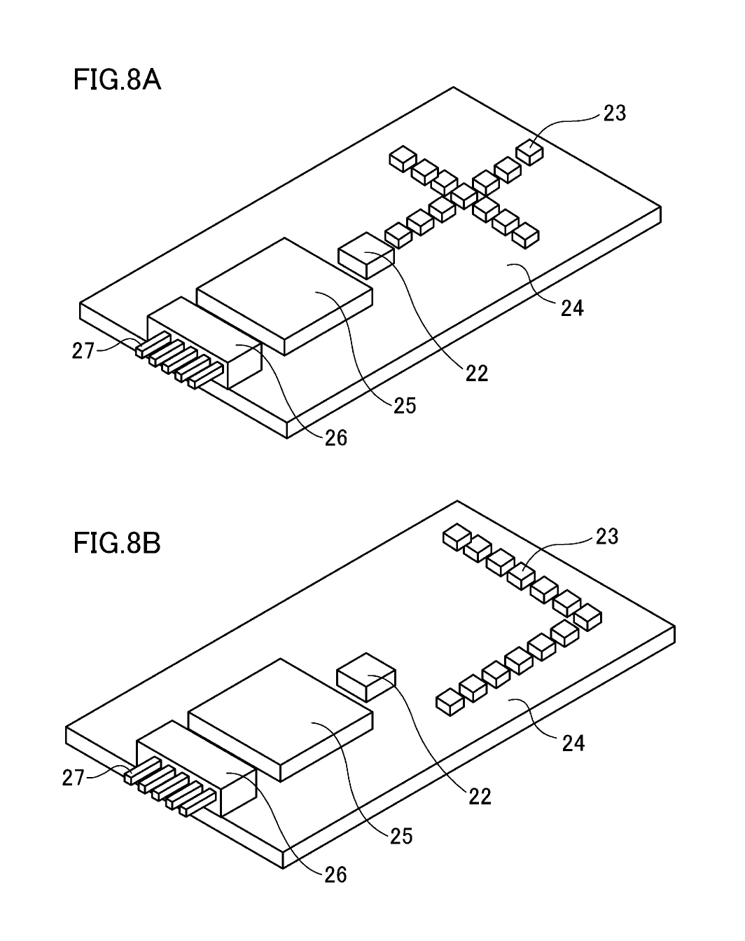

Example arrangements of a plurality of pressure wave receivers on the printed circuit board will be described with reference to FIGS. 8A and 8B. For example, the pressure wave receivers 23 may be arranged in the shape of a cross as shown in FIG. 8A, or in the shape of the letter L as shown in FIG. 8B. By thus arranging the pressure wave receivers 23 regularly in vertical and horizontal directions, a time difference occurs between pressure waves received by the pressure wave receivers 23, and therefore, the received signal can be identified as two- or three-dimensional information.

(Pressure Wave Receiver)

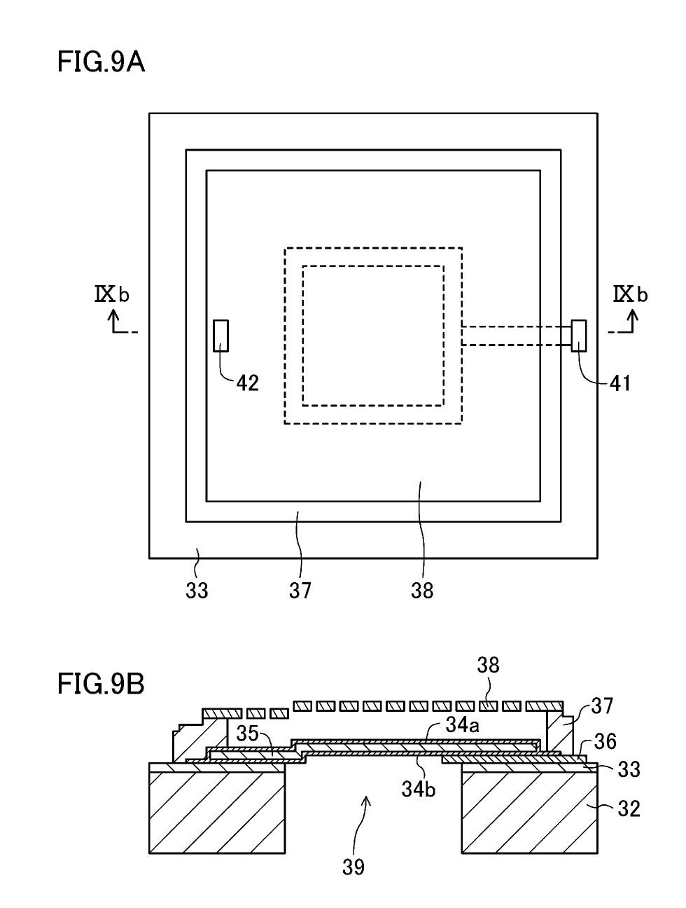

A structure of the pressure wave receiver 23 will be described with reference to FIGS. 9A and 9B. In FIG. 9A, a hole formed in a fixed film described below is not shown.

As shown in FIGS. 9A and 9B, a hole 39 is formed in a substrate, penetrating through the entire substrate including a silicon substrate 32 and a silicon oxide film 33 formed on the silicon substrate 32. A vibration film is formed to cover the hole 39. The vibration film includes a vibration electrode 36 formed, for example, of a polysilicon film doped with boron or phosphorus. Note that the vibration film may be a multilayer film including an insulating film 35 (e.g., a silicon oxide film, etc.) and insulating films 34a and 34b (e.g., a silicon nitride film, etc.). The vibration film is supported by a portion around the hole 39 of the silicon substrate 32, and therefore, functions as a film which is vibrated by pressure waves. A fixed film including a fixed electrode 38 formed, for example, of a polysilicon film doped with boron or phosphorus is formed to face the vibration film. Note that a plurality of holes are formed in the fixed film, through which pressure waves can pass. A gap is formed between the vibration film and the fixed film. The gap is determined by the thickness of a support portion 37 which supports the fixed film. Note that the gap may be formed by etching, by a semiconductor process, a sacrifice film which is originally formed between the fixed film and the vibration film. A portion of the sacrifice film may be left as the support portion 37. A pad 41 for the vibration electrode and a pad 42 for the fixed electrode may be used to transfer an electrical signal which is obtained when pressure waves are received, to circuitry external to the pressure wave receiver.

Although, in FIGS. 9A and 9B, the fixed film is provided above the vibration film, the present disclosure is not limited to this. The vibration film and the fixed film may be arranged in any position if the vibration film and the fixed film face each other to function as a capacitor. The support portion 37 and the sacrifice film are each a silicon oxide film, for example.

If the vibration film includes a silicon oxide film, the vibration film functions as an electret condenser microphone by storing permanent charge in the silicon oxide film. Therefore, it is no longer necessary to externally supply charge. In this case, the vibration film is preferably completely covered by the silicon nitride film in order to reduce or prevent moisture from being adsorbed by the silicon oxide film.

If it is assumed that pressure waves enter the pressure wave receiver thus configured from above, the pressure waves pass through the holes formed in the fixed film to reach the vibration film. As a result, the vibration film is vibrated by the pressure waves, so that a change occurs in the capacitance between the vibration electrode and the fixed electrode. The capacitance change can be read as a received signal of the pressure waves. Note that if pressure waves enter from below (the lower surface of the silicon substrate 32, a side on which the hole 39 is provided), the holes formed in the fixed film function as holes through which air in the gap is passed due to vibration of the vibration film.

An example method for manufacturing the pressure wave receiver will be briefly described hereinafter. Initially, the vibration electrode 36, the insulating film 34b, the insulating film 35, and the insulating film 34a are successively deposited on an oxidized surface (a surface of the silicon oxide film 33) of the silicon substrate 32, to form the vibration film. Next, the sacrifice film is deposited on the vibration film, the fixed film having the fixed electrode 38 is deposited on the sacrifice film, and thereafter, a plurality of holes are formed in the fixed film. Next, the hole 39 is formed by etching from the lower surface of the silicon substrate 32. In this case, it is more preferable that the hole 39 penetrate through the silicon substrate 32 to expose the vibration film. Next, the entire or a part of the sacrifice film is removed through the holes formed in the fixed film using wet etching solution, etc., to form a gap between the vibration film and the fixed film. Note that, in this case, a portion of the sacrifice film may be left as the support portion 37. The order in which the films in the vibration film are deposited is not limited to that described above. For example, the vibration electrode may be formed on the upper surface of the deposited insulating film. When the pressure wave receiver is formed on the same wafer on which the pressure wave generator is formed, it is preferable that the vibration electrode and the heat generating member be formed of the same material and be stacked together in the same order, and the heat insulating layer and the insulating films in the vibration film be formed of the same material and be stacked together in the same order.

(Variations of Second Embodiment)

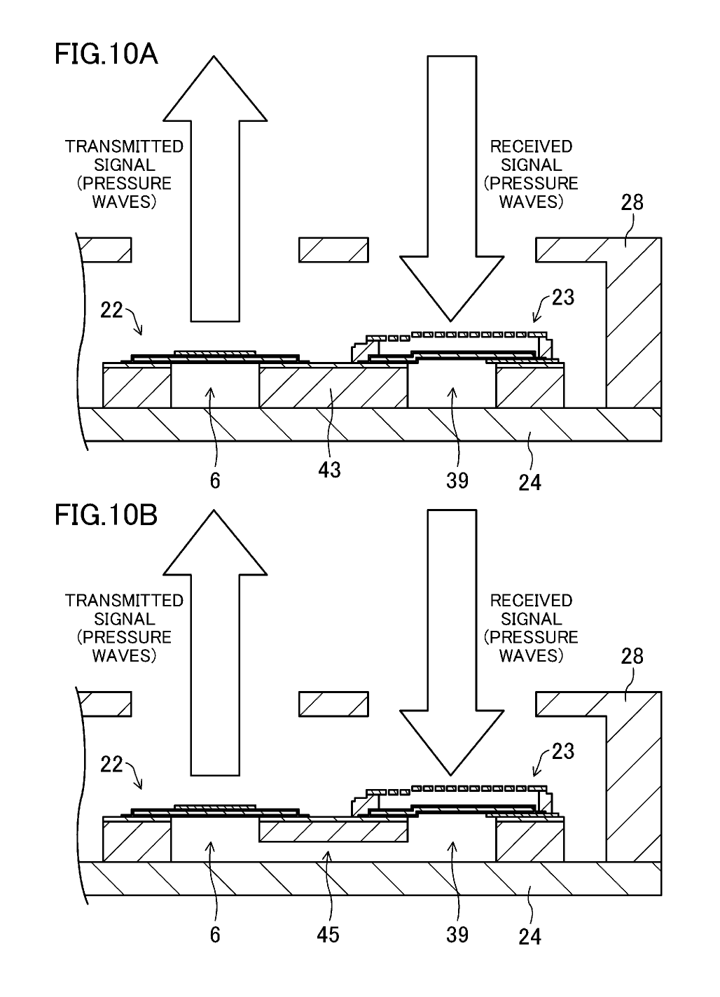

Devices according to variations of the second embodiment of the present disclosure will be described hereinafter with reference to FIGS. 10A-13B.

In a first variation of the second embodiment, as shown in FIG. 10A, a pressure wave generator 22 and a pressure wave receiver 23 may be formed on the same silicon substrate 43. In this case, the size of the entire device can be advantageously reduced, compared to when the pressure wave generator 22 and the pressure wave receiver 23 are mounted on separate substrates. In a second variation of the second embodiment, as shown in FIG. 10B, a hole 6 formed in a pressure wave generator 22 and a hole 39 formed in a pressure wave receiver 23 may be used as a common space 45. In the pressure wave receiver 23, a space opposite to the direction of incoming pressure waves functions as a back air chamber. Therefore, when pressure waves enter from above, the hole 39 functions as a back air chamber. The volume of the back air chamber is preferably increased in order to improve the acoustic characteristics. When the size of the pressure wave receiver 23 is reduced, the volume of the back air chamber disadvantageously decreases. Therefore, by forming the common space 45 which serves as both the hole 6 and the hole 39, the back air chamber can have a sufficient volume so that the acoustic characteristics can be advantageously improved.

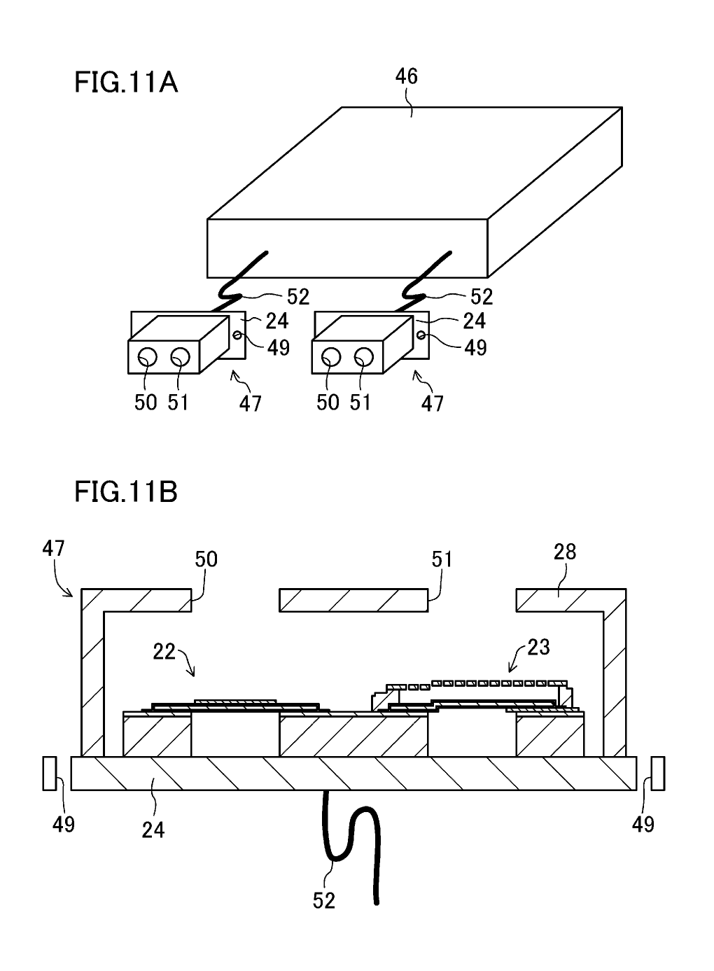

A device according to a third variation of the second embodiment of the present disclosure will be described with reference to FIGS. 11A and 11B.

FIG. 11B shows a device 47 in which a pressure wave generator 22 and a pressure wave receiver 23 are mounted on a printed circuit board 24, and a cover 28 having openings 50 and 51 at portions corresponding to the pressure wave generator 22 and the pressure wave receiver 23 is joined to the printed circuit board 24. FIG. 11A shows how the device 47 of the present disclosure is electrically connected to another electronic device 46 which includes other parts, such as a controller which processes signals for controlling the pressure wave generator 22 and the pressure wave receiver 23, etc., via a connection unit 52, such as a cable, etc. The electronic device 46 and the device 47 of the present disclosure are mechanically connected together by a connection member (e.g., a bolt, etc.) being inserted into a hole 49. Here, if the device 47 of the present disclosure is attached to the electronic device 46 which functions as a system, such as a robot, etc., the device 47 may function as a sensor. If the control function is thus concentrated in the electronic device 46, the size of the device 47 of the present disclosure including the pressure wave generator 22 which functions as a sensor can be further reduced. If a plurality of the devices 47 of the present disclosure are provided, two- and three-dimensional distance information of an object can be advantageously obtained compared to only one device 47 of the present disclosure is provided. Note that compared to when a plurality of the devices 47 of the present disclosure are provided on only one side, it is more preferable that the device 47 of the present disclosure be provided on at least two opposite sides. It is preferable that the device 47 of the present disclosure is provided on many sides of the electronic device 46.

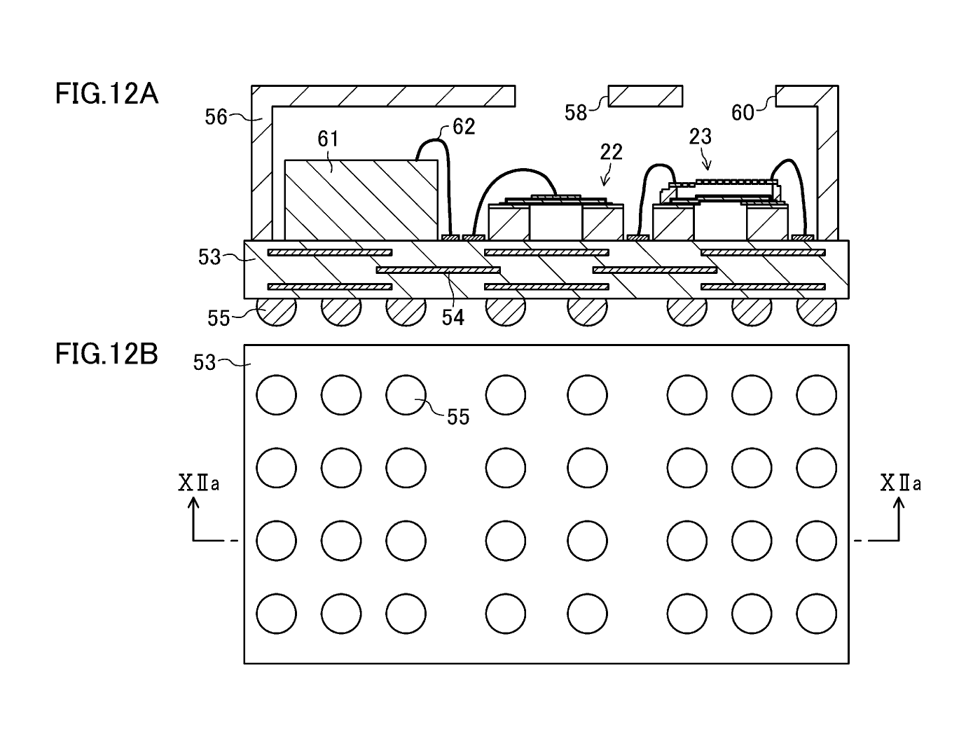

A device including a pressure wave generator according to a fourth variation of the second embodiment of the present disclosure will be described with reference to FIGS. 12A and 12B.

As shown in FIGS. 12A and 12B, a pressure wave generator 22, a pressure wave receiver 23, and a controller 61 which processes various signals are mounted on a printed circuit board 53. A cover 56 which covers the pressure wave generator 22, the pressure wave receiver 23, and the controller 61 is joined to the printed circuit board 53. A first opening 58 corresponding to the pressure wave generator 22 and a second opening 60 corresponding to the pressure wave receiver 23 are formed in the cover 56. The pressure wave generator 22, the pressure wave receiver 23, and the controller 61 are electrically connected together via multilayer interconnects 54 formed in the printed circuit board 53. The multilayer interconnects 54 are electrically connected to solder balls 55 provided on the lower surface of the printed circuit board 53. Note that the multilayer interconnect 54, the pressure wave generator 22, and the pressure wave receiver 23 are connected to the printed circuit board 53 via bonding wires 62.

Thus, the device of the present disclosure may be electrically connected to an external device via the solder ball provided on the lower surface of the printed circuit board instead of a connector protruding from a side wall of the cover. By providing a connection unit, such as solder balls, etc., is provided on the lower surface of the printed circuit board, the device of the present disclosure can be directly mounted on a surface of a circuit board of an external device. Therefore, if a large number of the devices of the present disclosure need to be mounted, the manufacturing time can be advantageously reduced.

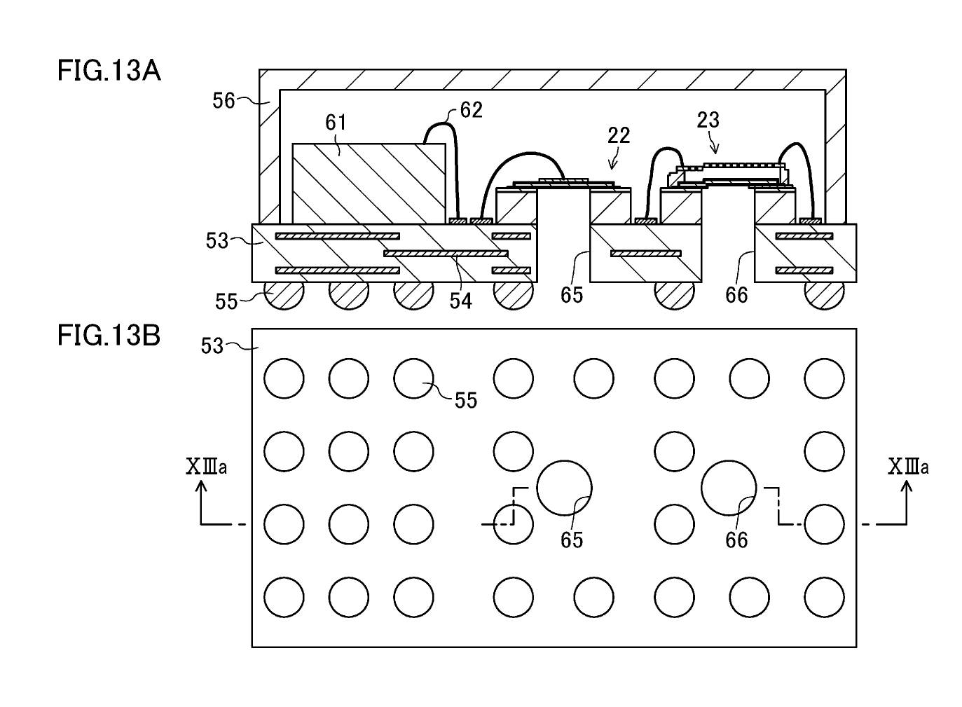

A device according to a fifth variation of the second embodiment will be described with reference to FIGS. 13A and 13B. In FIGS. 13A and 13B, a first opening 65 corresponding to a pressure wave generator 22 and a second opening 66 corresponding to a pressure wave receiver 23 are formed on a printed circuit board 53, unlike that shown in FIGS. 12A and 12B. When the device of FIGS. 13A and 13B is connected to an external device, then if the external device includes a flexible substrate of polyimide, etc., the thickness of the entire structure can be reduced.

Note that, as shown in FIG. 5, the pressure wave generator 22 preferably includes a film formed of the heat generating member 5 and the heat insulating layer which are successively formed from the side on which the hole 6 is provided. The present disclosure is not limited to this. For example, a pressure wave generator (FIGS. 1A and 1B) which includes a film formed of the heat insulating layer and the heat generating member 5 which are successively formed from the side on which the hole 6 may be mounted on a printed circuit board with a surface in which the heat generating member 5 is formed making contact with the printed circuit board.

Although, in this embodiment, the pressure wave receiver 23 is mounted on the printed circuit board 24 with the lower surface of the silicon substrate making contact with the printed circuit board 24, the surface in which the fixed film is provided may make contact with the printed circuit board.

In this embodiment, if the pressure wave generator 22 and the pressure wave receiver 23 are simultaneously formed by a semiconductor process, the pressure wave generator 22 and the pressure wave receiver 23 can have the same material and configuration. For example, the pressure wave generator 22 and the pressure wave receiver 23 can include the same silicon substrate, and the holes formed therein can have the same depth. The heat generating member of the pressure wave generator 22 and the vibration electrode of the pressure wave receiver 23 can be formed of the same material and have the same thickness. The heat insulating layer of the pressure wave generator 22 and the insulating films in the vibration film of the pressure wave receiver 23 can be formed of the same materials, and these materials can each have the same thickness. By forming the pressure wave generator and the pressure wave receiver on the same wafer as described above, the cost can be advantageously reduced.

The present disclosure is useful as a device which heats gas, such as air, etc., to generate pressure waves, and irradiates an object with the pressure waves, and detects the pressure waves reflected from the object.

What is claimed is:

1. A pressure wave generator comprising:
a silicon substrate;
a hole formed in the silicon substrate; and
a film covering the hole,
wherein
the film includes a multilayer film of a heat generating member and a heat insulating layer.

2. The pressure wave generator of claim 1, wherein
the heat generating member is formed of polysilicon doped with boron or phosphorus.

3. The pressure wave generator of claim 1, wherein
a surface of the heat generating member opposite to a side on which the heat insulating layer is formed, and a side surface of the heat generating member, are covered by a barrier layer including an insulating film.

4. The pressure wave generator of claim 1, wherein
the heat insulating layer is a multilayer film of a silicon oxide film and a silicon nitride film.

5. The pressure wave generator of claim 4, wherein
the silicon oxide film is covered by the silicon nitride film.

6. The pressure wave generator of claim 1, wherein
in the film, the heat generating member and the heat insulating layer are successively stacked together from a side on which the hole is provided.

7. The pressure wave generator of claim 1, wherein
the heat generating member generates pressure waves on a side opposite to a side on which the heat insulating layer is formed.

8. The pressure wave generator of claim 1, wherein
a pad is formed on the heat generating member, and an alternating current is applied via the pad to the heat generating member.

9. A device comprising:
the pressure wave generator of claim 1; and
a pressure wave receiver,
wherein
the pressure wave receiver includes a capacitor including a vibration film and a fixed film.

10. The device of claim 9, further comprising:
a cover covering the pressure wave generator and the pressure wave receiver, wherein
the pressure wave generator and the pressure wave receiver are mounted on a printed circuit board.

11. The device of claim 10, wherein
the cover includes an opening corresponding to each of the pressure wave generator and the pressure wave receiver.

12. The device of claim 10, wherein
the cover includes a first opening corresponding to the pressure wave generator and a second opening corresponding to the pressure wave receiver.

13. The device of claim 10, wherein
the printed circuit board includes a first opening corresponding to the pressure wave generator and a second opening corresponding to the pressure wave receiver.

14. The device of claim 12, wherein
a mesh is formed at each of the first and second openings.

15. The device of claim 10, wherein
the pressure wave generator and the pressure wave receiver are formed on the same silicon substrate.

16. The device of claim 15, wherein
the pressure wave receiver further includes a silicon substrate having a hole, and
the hole in the silicon substrate of the pressure wave receiver and the hole in the silicon substrate of the pressure wave generator share a space.

17. The device of claim 10, wherein
there are a plurality of the pressure wave receivers mounted on the printed circuit board and are arranged in a line on the printed circuit board.

18. The device of claim 10, wherein
there are a plurality of the pressure wave receivers mounted on the printed circuit board and are arranged in a cross shape on the printed circuit board.

19. The device of claim 10, wherein
there are a plurality of the pressure wave receivers mounted on the printed circuit board and are arranged in an L-shape on the printed circuit board.

20. The device of claim 10, wherein
the device is electrically connected to another electronic device at a surface of the printed circuit board and the cover perpendicular to a surface of the printed circuit board on which the pressure wave generator is mounted.

21. The device of claim 10, wherein
the device is electrically connected to another electronic device at a surface of the printed circuit board opposite to a surface of the printed circuit board on which the pressure wave generator is mounted.

22. The device of claim 21, wherein
the another electronic device includes a controller which controls the pressure wave generator and the pressure wave receiver.

23. The device of claim 21, wherein
the device is electrically connected to the another electronic device via a bump formed on the surface of the printed circuit board opposite to the surface of the printed circuit board on which the pressure wave generator is mounted.

24. The device of claim 10, wherein
the heat generating member and a vibration electrode included in the vibration film are formed of the same material, and
the heat insulating layer and parts other than the vibration electrode of the vibration film are formed of the same material.

25. A device comprising:
a pressure wave generator;
a pressure wave receiver;
a printed circuit board on which the pressure wave generator and the pressure wave receiver are mounted; and
a cover covering the pressure wave generator and the pressure wave receiver.

26. The device of claim 25, wherein
the pressure wave generator includes a silicon substrate, a hole in the silicon substrate, and a film covering the hole, and
the film includes a multilayer film of a heat generating member and a heat insulating layer which are successive formed from a side on which the hole is formed.

27. The device of claim 25, wherein
a first opening corresponding to the pressure wave generator and a second opening corresponding to the pressure wave receiver are formed in the printed circuit board.

28. The device of claim 25, wherein
the device is electrically connected to another electronic device at a surface of the printed circuit board and the cover perpendicular to a surface of the printed circuit board on which the pressure wave generator is mounted.

29. The device of claim 25, wherein
the device is electrically connected to another electronic device at a surface of the printed circuit board opposite to a surface of the printed circuit board on which the pressure wave generator is mounted.

30. The device of claim 29, wherein
the another electronic device includes a controller which controls the pressure wave generator and the pressure wave receiver.

31. The device of claim 29, wherein
the device is allowed to be mounted on a surface of the another electronic device.

32. The device of claim 25, wherein
the substrate of the pressure wave generator and the substrate of the pressure wave receiver are formed of the same material,
the heat generating member of the pressure wave generator and a vibration electrode in the vibration film of the pressure wave receiver are formed of the same material, and
the heat insulating layer of the pressure wave generator and parts other than the vibration electrode in the vibration film of the pressure wave receiver are formed of the same material.
